(19) United States
(12) Patent Application Publication
(10) Pub. No.: US 2005/0262526 A1
(43) Pub. Date: Nov. 24, 2005

(54) Interactive television channel

(76) Inventor: Grzegorz Lindenberg, Cezarow (PL)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 11/108,160

(22) Filed: Apr. 18, 2005

Related U.S. Application Data
(60) Provisional application No. 60/562,606, filed on Apr. 16, 2004.

(51) Int. Cl. H04N 7/173; H04H 9/00; H04N 7/16

(52) U.S. Cl. 725/1; 725/9; 725/25; 725/29

(57) ABSTRACT

An interactive television channel receives and displays view-submitted programming materials for a fee. Embodiments of the invention verify user payment of fees. User-submitted programming may be automatically evaluated and edited in real time. Broadcast and editing fees may be dynamically estimated and automatically levied. The viewer-submitted materials is optionally grouped into a framework that clusters blocks of similar programming. Other embodiments connect users to an editing application that allows the editing of the programming or automatically edit the programming as needed for broadcasting by modifying the length of the broadcast or removing undesired content. Similarly, embodiments of the present invention may add embellishments, such as such as graphics, music, or commentary, to the viewer-submitted materials. The user-supplied programming may be augmented with additional programming, such as instructional videos explaining the process of program submission and editing.

### CROSS REFERENCE TO RELATED APPLICATIONS

This patent application claims priority under 37 C.F.R. §1.53(c) to U.S. Provisional Application No. 60/562,606 filed on Apr. 16, 2004, the subject matter of which is hereby incorporated by reference in full.

### SPONSORED RESEARCH OR DEVELOPMENT

Not Applicable.

### SEQUENCE LISTINGS

Not Applicable.

### BACKGROUND OF THE INVENTION

1. Field of the Invention

The present invention provides a programming channel that displays viewer-submitted materials for a fee, where the viewer-submitted materials may be grouped into a framework that clusters blocks of similar programming, and where the view-submitted materials may be edited as needed, such as through the addition of embellishments including graphics, music, or commentary.

2. Discussion of the Related Art

Various known technologies enable a viewer to customize a video display, but where that viewer does not provide the contents of the displays. For example, U.S. Pat. No. 6,498,987, issued to Kelly, et al. on Dec. 24, 2002 provides a SYSTEM AND METHOD FOR PROVIDING PERSONALIZED WEATHER REPORTS AND THE LIKE, in which a viewer specifies a geographic area of interest and displayed weather information is customized to the specified area. Likewise, U.S. patent application Ser. Nos. 20030167470 and 20020095677 applied for by Davis, et al. on Sep. 4, 2003 and Jul. 18, 2002, provides a METHOD AND SYSTEM FOR SUPPLEMENTING TELEVISION PROGRAMMING WITH E-MAILED MAGAZINES that presents a user interface that accepts a viewer request and modifies a broadcast to display an electronically stored information associated with the request. Similarly, U.S. patent application Ser. No. 20020053084, applied for by Escobar, et al. on May 2, 2002, presents a CUSTOMIZED ELECTRONIC PROGRAM GUIDE (EPG) in which a viewer's input is analyzed, and the content for a displayed EPG is customized based on the viewer's analyzed input. The viewer's input may include signals indicating a change of channels, a guide selection, a category selection, a programming selection, a recorded programming, a viewed web page, and a rating of show. The customized EPG may include an interactive link, a web page, a chat room, an advertisement, a program guide, a TV channel, a customized viewer interactive EPG interface, and one or more mini-guides.

Other known technology targets advertising to a viewer based on selections by that viewer, but again the viewer does not provide the displayed contents. For example, U.S. Pat. No. 5,791,991 issued to Small on Aug. 11, 1998 provides an INTERACTIVE CONSUMER PRODUCT PROMOTION METHOD AND MATCH GAME in which an information screen is displayed on an interactive electronic terminal, such as a personal computer, interactive television, in-store kiosk, etc. The displayed information screen includes a listing of popular consumer product categories, along with a matrix of spaces representing a match game such as Bingo or Keno. The game is played by comparing selected consumer product categories with preselected spaces on the matrix to detect matches and corresponding prizes, such as coupons or rebate offers for related products.

Other known technology allows a user (such as producer) to select and modify existing material for broadcast to viewers. For instance, U.S. patent application Ser. No. 20030084443, applied for by Laughlin, et al. on May 1, 2003 and entitled SYSTEM AND METHOD FOR CREATING PROGRAM ENHANCEMENTS FOR USE IN AN INTERACTIVE BROADCAST NETWORK, allows a user to select a group of products, select and customize a screen layout, and define a program enhancement associating the products and layout with a particular scheduled program. Each program enhancement created with the system is stored for broadcast to viewers on the network at an appropriate time prior to the scheduled broadcast of the particular program with which it is associated.

Other known technology may automatically modify stored, existing programming and then broadcast this modified programming. For example, U.S. patent application Ser. No. 20010013123 applied for by Freeman, et al. on Aug. 9, 2001 and entitled CUSTOMIZED PROGRAM CREATION BY SPLICING SERVER BASED VIDEO, AUDIO, OR GRAPHICAL SEGMENTS allows customized program creation by splicing server based video, audio, or graphical segments. Specifically, that application provides for a programming transmission center to maintain a single or multiple MPEG storage server environments. Through the use of digital conversion and MPEG compression standards, a library of programming and other information signals is stored on the file servers. The transmission center selects and accesses programming segments or other information from the storage servers. Through the use of splice points encoded through the MPEG process, the programming transmission center splices disparate program segments together to create a single custom program stream for delivery to a user.

Still other known technology allows a viewer to participate in creating or modifying the contents of the computer display. For example, U.S. patent application Ser. No. 20030196206, applied for by Shusman on Oct. 16, 2003 teaches a METHOD AND APPARATUS FOR INTERNET-BASED INTERACTIVE PROGRAMMING in which a moderator may create and display text or images in the form of an interactive program. Registered viewers may similarly view and edit the interactive program. The interactive program is typically distributed as electronic documents over a computer network such as the Internet, but may alternatively be converted to conventional interactive television content for distribution over an interactive television network.

However, there is no known technology in which an interactive programming channel displays viewer-submitted materials for a fee. Furthermore, no known technology accepts and groups the viewer-submitted materials into a framework that clusters together blocks of similar programming. Similarly, no known technology edits or otherwise adds embellishments, such as such as graphics, music, or commentary, to the viewer-submitted materials broadcasted on the interactive channel.

### BRIEF SUMMARY OF THE INVENTION

In response to these and other needs, the present invention provides a system and method for accepted programming material from viewers, editing this material, and then broadcasting the material for a fee. Specifically, the present invention provides an interactive television channel that receives and displays view-submitted programming materials for a fee. Embodiments of the invention verify user payment of fees. Other embodiments of the invention optionally group and organize the viewer-submitted materials in real time into a framework that clusters blocks of similar programming, according to user supplied data. Other embodiments of the present invention optionally edit the viewer-submitted programming as needed for broadcasting. Similarly, embodiments of the present invention accept user supplied data and uses this data to add embellishments such as graphics, music or commentary to the viewer-submitted materials. In these various embodiments, the fees associated with the editing and transmission of the viewer-provided programming may be assessed automatically.

### BRIEF DESCRIPTION OF THE DRAWINGS

These and other advantages of the present invention are described more fully in the following drawings and accompanying text in which like reference numbers represent corresponding parts throughout:

FIG. 1 depicts the steps in a method for implementing an interactive television channel in accordance with an embodiment of the present invention; and

FIG. 2 is a schematic illustration of an interactive television network for implementing the method of FIG. 1, in accordance with an embodiment of the present invention.

### DETAILED DESCRIPTION OF THE PREFERRED EMBODIMENTS

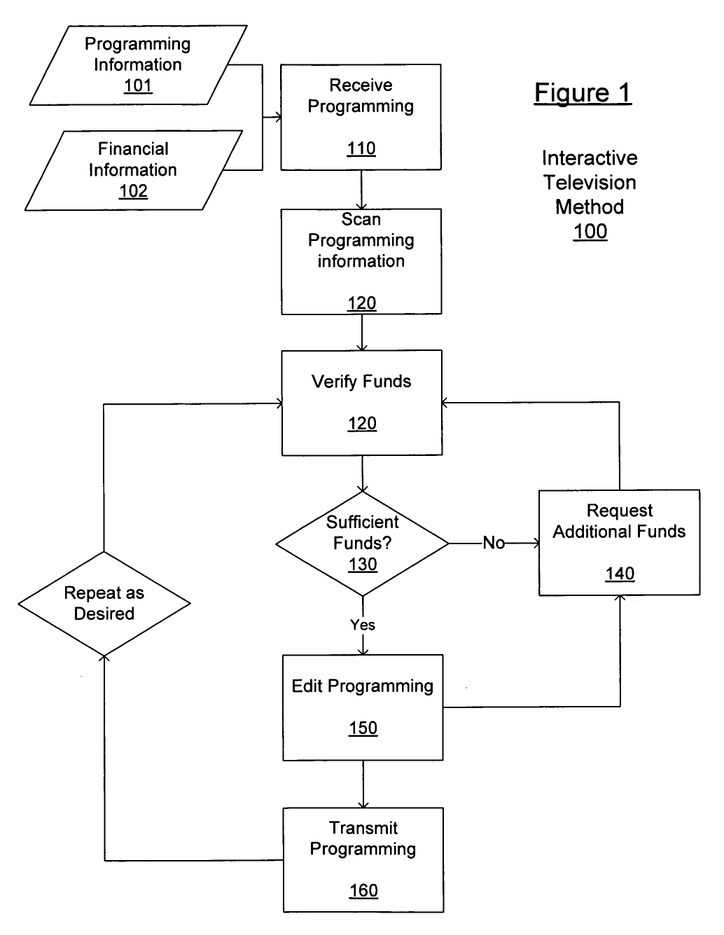

As depicted in FIG. 1, the present invention provides an interactive television method 100 for accepting programming information 101 from users and broadcasting this programming information 101 for a fee. In particular, the method generally includes the receiving of the programming information 101 from the user in step 110. The receiving of the programming information 101 in step 110 may include various processes such as the electronic transmission of the programming information, for instance, through a network such as the Internet. Alternatively, the programming information may be alternatively stored in a variety of known physical media (e.g., tapes, DVD, etc.) and physically delivered from the viewer. The programming information 101 may be stored upon receipt, as needed for subsequent editing and public broadcasting. For instance, the programming information may be stored in an electronic storage device or network, as described in greater detail below.

The viewer-created programming information 101 may be, for example, a tape of the viewer singing, a marriage proposal, a wedding video, a single's advertisement for a date, a homemade movie, a vanity film, etc.

The programming information received in step 110 may be further accompanied by financial information 102. The financial information 102 may simply be a notation of a payment or payment information, such as a credit, information, bank account number, or another financial ledger indicating a particular payment balance or source of funds.

In step 120, the fees associated with a broadcast are dynamically determined in real time according to the viewer-created programming information 101 and other user supplied information. For example, the overall costs may depend on the total length of the broadcast material, the general nature of the material, its attractiveness and the outlay of the editor's work, etc. In some special cases, the material (e.g., broadcast for a charity or other public interest) may be broadcast for free.

Optionally, in step 120, known technology may be used to scan or otherwise automatically evaluate the viewer-created programming information 101 to dynamically ascertain information as needed to categorize the submission and to form a fee calculation. For example, digital recognition may be used to automatically identify the subject matter of the submission.

This payment balance may then be verified in step 130 to insure that sufficient payment exists, as needed to fund the editing and broadcast of the viewer-supplied programming 101. If there are adequate funds, then the amount is acquired in step 130. Otherwise, a message may be sent to the user to request additional funds in step 140. Then the viewer-supplied programming 101 may be prepared and edited in step 150 and broadcasted in step 160.

The editing of the viewer-supplied programming 101 in step 150 generally seeks to make the broadcast more attractive, by designing a special setting for the materials. For instance, the viewer-supplied programming 101 may be decorated with links to computer graphics. A musical background may be added as well. Similarly, commentary by the station or by the viewer/creator may be added as well.

A fee may be assessed for any editing work or user access to editing technology, and this additional editing fee may be collected in a similar manner to the broadcast fees acquired in step 120.

One preferred implementation of the present invention uses a presenter associated with the broadcast to introduce or otherwise comment on the viewer-supplied programming 101. For example, the presenter may announce consecutive materials, make comments on the materials, or evaluate these materials.

The editing in step 150 may further include the grouping of related viewer-supplied programming 101. Thus, the material sent by viewers may be grouped in frameworks (e.g., shows or programs) so that the broadcast is not a boring cluster of amateurs' shows. The programming merely provides general rules and a framework for ordering the viewer-supplied programming 101. The show grouping may include, for example”:
all matters concerning house, cuisine, children and family advice, especially addressed to homemakers with topics related to cooking recipes they want to share and house problems;
weddings and wedding parties;
films about other family ceremonies such as baptisms, anniversaries, and funeral services.
artistic performances that gives the floor to soloists, musical bands, dancing and theater groups.
children pictures and videos;
pet pictures and videos;
jokes told and filmed by camera and cabaret performances;.
user-created entertainment movies and television shows;
confessions of serious problems and disclosing secrets concerning unhappy love, sexual problems, alcohol problems, etc.;
late night programs on private erotica matters;
a mixture of the best offers and demos that for any reason have not been introduced in the other subject blocks; and
classified advertisements, advertising, announcements,: job wanted, cars for sale, advertising on the car body and sales in shops.
   When the number of the attractive material exceeds the capacity of the given block, it will be possible to create new subject channels (e.g. weddings, music, etc.) as needed.

Continuing with editing in step 150, the materials may be edited by cutting and splicing the viewer-supplied programming 101 with special effects and titles. For example, the viewer-supplied programming 101 may be broadcast with a note about the creator, a title, place and time of recording. The material may be edited or otherwise modified (e.g., by speeding/slowing the materials) to fit within a desired programming block, typically from 1 to 10 minutes, or even longer in special cases. Overall, preferred implementations of the present invention seek to create television broadcast that looks authentic and realistic but professional, in order to make the viewer-supplied programming 101 more watchable by the public. The editing in step 150 may further include adding previews announcing upcoming displays of various viewer-supplied programming 101. In another embodiment, the transmission of the viewer-supplied programming 101 may be supplemented with programming that gives viewers training in video filming and editing techniques. In a similar fashion, the viewer-supplied programming 101 may be edited as required for public airing to conform to broadcast laws and restrictions.

Overall, the editing in step 150 seeks to make the programming watchable by the public. It should be appreciated, however, that the viewer-supplied programming 101 is preferably edited as little as possible so that programming remains authentic to the user's intent and creation.

If there are sufficient funds, as determined in step 130 and after editing in step 150, the viewer-supplied data is transmitted to the public in step 160. The transmission 160 occurs using known techniques. For example, the edited viewer-supplied programming 101 may be served out over a network so that viewers may observe the programming on a computer. More typically, the viewer-supplied programming 101 is transmitted over air or through a cable/satellite for viewing on a television.

Subsequently, the process 100 may repeat from step 120 to 160. In particular, the viewer-supplied programming 101 may be repeatedly rebroadcast, with each broadcast having a separate fee to the user. Alternatively, the viewer-supplied programming 101 may be repeatedly broadcast for a predefined time period, as negotiated with the viewer. Once the payment balance is depleted, a message may be sent to the viewer in step 140 to request additional funds to continue broadcast of the viewer-supplied programming 101. As part of the cycle, the programming material may be edited in step 150 for each separate broadcast as desired to differentiate the different broadcasts and to otherwise make the broadcast less visually redundant. Typically, the whole program (created by combining materials from multiple viewers) lasts from 4 to 8 hours and is repeated several times every 24 hours.

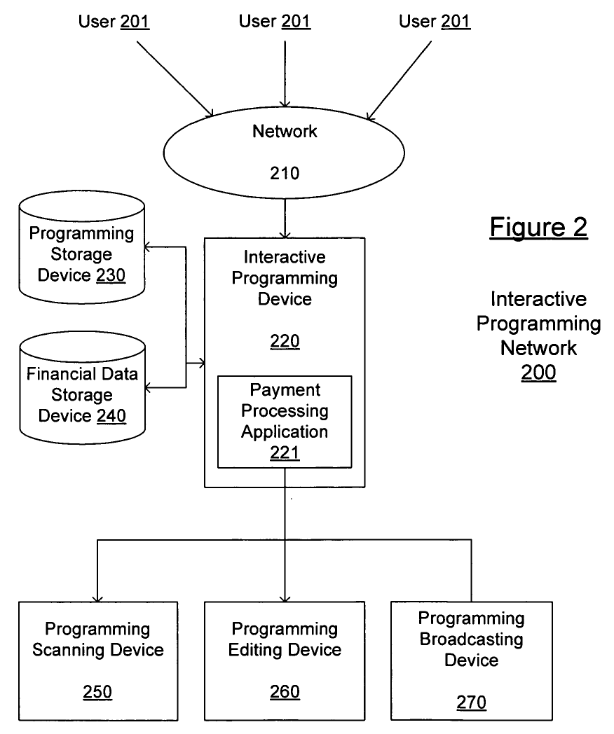

Turning now to FIG. 2, the method 100 may be implemented using an interactive television network 200, which allows users 201 to transmit programming via a network 210, such as the Internet or an intranet. As described above, the user 201 may transmitted digitally stored programming or may convert analog programming into a digital format for forwarding. Alternatively, the creator of programming material may forward the program in an analog format, such as film or tape, to an employee that converts the programming material into an alternative format as needed for evaluation, editing, storage, and broadcast.

The programming is then received by an interactive programming device 220, which stores the programming information and the user's financial data in programming storage devices 230 and financial storage device 240, which may be databases. It should be appreciated the storage devices 230 and 240 may be any know storage technology, such as disk drives, optical media, tape drives, storage area networks (SANs), etc. Alternatively, the storage devices may be libraries of tapes, discs, or other storage media.

The interactive program device 220 may be a personal computer programmed to implement the steps in the interactive television method 100. For example, a programmer may use the interactive television device 220 to verify sufficient funds as needed to cover charges associated with editing and transmission of the viewed-supplied programming. The device 220 general includes a payment processing application 221 that evaluates the financial data, as received from the user 201 and as stored in the financial data storage device 240 to determine the sufficiency of payment to proceed with editing and broadcast of the user supplied programming material.

The interactive programming device 220 may optionally use a programming scanning device 240 that operates according to know technology to evaluate the content of the user-supplied programming material. The results may be used by the billing module 221 or by the editing device 260.

The interactive programming device 220 may then use a known application to edit the viewed-supplied programming as needed for transmission using a programming editing device 260. Overall, programming editing device 260 seeks to make the programming watchable by the public. It should be appreciated, however, that the viewer-supplied programming is preferably edited as little as possible so that programming remains authentic to the user's intent and creation.

The program-editing device 260 may be integrated with the interactive television device 220, such as computer program adapted to modify the images or sound of programming as needed for broadcast. As suggested above, the program editing device seeks to make the broadcast more attractive, for example, by designing a special setting for the materials. For instance, the viewer-supplied programming may be decorated with computer graphics and a musical background may be added. Similarly, commentary by the station or by the viewer/creator may be added as well. Thus, in one implementation of the present invention, the editing device 260 automatically adds a presenter associated with the broadcast to introduce or otherwise comment on the viewer-supplied programming. For example, the presenter may announce consecutive materials, make comments on the materials, or evaluate these materials.

The program editing device 260 may be programmed to automatically add recorded presenter dialog and images according to results from the programming scanning device 250. The material may be edited or otherwise modified (e.g., by speeding/slowing the materials) to fit within a desired programming block, typically from 1 to 10 minutes, or even longer in special cases. Thus, the program editing device 260 may automatically edit the user supplied programming according the resulted from programming scanning device 250, as needed. For example, filler materials may be added to extend the user-supplied programming to a desired time duration as needed for standardized programming length. Similarly, the programming may be edited or compressed to shorten a broadcast.

In a similar fashion, the viewer-supplied programming may be edited as required for public airing to conform to broadcast laws and restrictions. Thus, program editing device 260 may operate in real time to dynamically edit the programming to crop or remove objectionable subject matter, dialogue or images identified by the programming scanning device 250.

The program editing device 260 may group related viewer-supplied programming according the programming scanning device 250 or user specified data inputs. Thus, the material sent by viewers may be grouped in frameworks (e.g., shows or programs) so that the broadcast is not a boring cluster of amateurs' shows. The programming merely provides general rules and a framework for ordering the viewer-supplied programming. When the number of the attractive material exceeds the capacity of the given block, it will be possible to create new subject channels (e.g. weddings, music, etc.) as needed.

The program editing device 260 may further cut and splice the viewer-supplied programming with special effects and titles. For example, the viewer-supplied programming may be broadcast with a note about the creator, a title, place and time of recording. Overall, preferred implementations of the present invention seek to create television broadcast that looks authentic and realistic but professional, in order to make the viewer-supplied programming 101 more watchable by the public.

The program editing device 260 may further add previews of upcoming displays of various viewer-supplied programming. In another embodiment, the transmission of the viewer-supplied programming may be supplemented with programming that gives viewers training in video filming and editing techniques.

The edited viewed-supplied programming is then re-stored in the programming storage devices 230, and then may be broadcast using a transmission device 270. The transmission device 270 is generally known, includes technology related to the retransmission of the viewer-supplied programming through the network 210 or through an on-air on through cable/satellite broadcast. The interactive television device 220 may then adjust the financial storage device 240 to reflect the fees associated with the editing and the broadcast.

Conclusion

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. An automated method for implementing an interactive television channel, the method comprising the steps of:
a computer receiving programming from a user;
said computer verifying sufficiency of funds from the user;
editing the programming, and
transmitting the edited programming.

2. The method of the claim 1 further comprising the step of the computer scanning the programming.

3. The method of claim 2, wherein the further comprising the step of the computer calculating a fee based on findings from the step of scanning of the programming.

4. The method of claim 2 wherein the editing step is dynamically performed by the computer based on findings from the step of scanning of the programming.

5. The method of claim 4 wherein editing step comprises the computer modifying the programming to fit a predefined time duration.

6. The method of claim 4 wherein editing step comprises the computer removing undesired material identified from the step of scanning of the programming.

7. The method of claim 1 wherein the editing step comprises grouping the programming with another programming with a similar subject matter.

8. The method of claim 7, wherein the computer schedules a program grouping according to the subject matter of the grouping.

9. The method of claim 1 wherein the editing step comprising the computer providing an editing application to the user, wherein the editing application modifies the programming as desired.

10. The method of claim 1 further comprising the step of sequentially transmitting a predefined second programming.

11. The method of claim 1 further comprising the step of retransmitting the edited programming at least one time.

12. The method if claim 11 wherein the retransmitting step occurs until the user's funds are exhausted.

13. The method of claim 1 wherein the editing step comprising adding audio and video embellishments to the programming.

14. An automated system for implementing an interactive television channel, the system comprising:
a user that supplies programming and financial data;
a network that connects the user to a computer that automatically receives, processes, and stores the programming and the financial data;
a payment processing application resident on the computer for verifying a predefined payment from the user;
a program editing device for modifying the programming; and
a broadcasting device for transmitting the modified programming.

15. The system of claim 14 further comprising a programming scanning device that evaluates content of the programming.

16. The system of claim 15 wherein the program editing device modifies the programming according to results produced by the programming scanning device.

17. The system of claim 16, wherein the program editing device removes undesired content from the programming identified by the programming scanning device.

18. The system of claim 14, wherein the program editing device modifies the programming to fit a predefined time duration.

19. The system of claim 14, wherein the program editing device groups the programming with another programming with a similar subject matter.

20. The system of claim 14 wherein the computer causes the broadcasting device to retransmit the modified programming one or more times according to a predefined condition.
